(19) United States
(12) Patent Application Publication
(10) Pub. No.: US 2003/0072477 A1
(43) Pub. Date: Apr. 17, 2003

(54) Karyotype processing methods and devices

(76) Inventor: Ashwin Kotwaliwale, Scotland (GB)

Correspondence Address: HAYNES BEFFEL & WOLFELD LLP, P O BOX 366, HALF MOON BAY, CA, 94019, US

(21) Appl. No.: 10/154,888

(22) Filed: May 24, 2002

Related U.S. Application Data
(60) Provisional application No. 60/329,213, filed on Oct. 12, 2001.

(51) Int. Cl. G06K 9/00

(52) U.S. Cl. 382/129

(57) ABSTRACT

The present invention includes methods of and devices to create, maintain and take advantage of a cytogenetic database. Particular aspects of the present invention are described in the claims, specification and drawings.

### RELATED APPLICATION DATA

The present application claims the benefit of, and incorporates by reference as if fully set forth herein, U.S. Provisional Application No. 60/329,213, entitled KARYOTYPE MANIPULATION SOFTWARE, filed Oct. 12, 2001, invented by Ashwin Kotwaliwale.

### BACKGROUND OF THE INVENTION

1. Field of the Invention

The present invention relates to the field of cytogenetic studies and, more particularly, to methods and devices for processing karyotypes of chromosomes.

2. Background

Cytogenetics involves the study of human chromosomes in health and disease. It is possible to diagnose disease states caused by abnormal chromosome number and/or structure. Chromosomes are complex structures located in the cell nucleus. They are composed of DNA, histone and non-histone proteins, RNA, and polysaccharides. They are basically the “packages” that contain the DNA. Normally chromosomes cannot be seen with a light microscope but during cell division they become condensed enough to be easily analyzed at 1000×.

Chromosome studies are an important laboratory diagnostic procedure in prenatal diagnosis, in certain patients with mental retardation and multiple birth defects, in patients with abnormal sexual development, and in some cases of infertility or multiple miscarriages. Cytogenetic analysis is also useful in the study and treatment of patients with malignancies and hematologic disorders. New techniques allow for increased resolution of chromosome banding patterns, permitting differentiation of a greater number of abnormalities.

Genetic laboratories serve as a link between the medical community's increasing knowledge of genetics and a patient's understanding of genetic risks. The patient is made aware of the risks associated with birth defects, hereditary disorders and diseases through interpreting family history, laboratory results and other medical information. The objective is to help the patient in deciding the best course of action for family planning. Continuing education is offered to referring doctors to assist them in the complexities of genetic risks and diseases and their management.

Congenital anomalies can be detected by doing the chromosome analysis, typically before birth. Such defects include ambiguous genitalia, cleft lip/palate, congenital heart disease, neural tube defects associated with genetic disorders in neonatal cases, developmental delay/mental retardation in pediatrics, primary amenorrhea, testicular feminization in adolescent cases, histories of infertility and multiple miscarriages, and a family history of a chromosome abnormality. Chromosome analysis often uses a sample of genetic material obtained from chorionic villi, amniotic fluid or fetal blood. Chorionic villi can be sampled by the so-called CVS procedure between 10th and 12th week of pregnancy. Amniotic fluid can be obtained through an amniocentesis usually between the 13th and 18th week of pregnancy. Fetal blood can be obtained through a percutaneous umbilical blood sample (PUBS) in special cases where results are needed immediately. PUBS samples also are obtained in some cases to clarify amniotic fluid or CVS test results or for late booking patients.

After birth, for instance after a miscarriage, tissue can be analyzed for chromosome abnormalities. Typical tissue sources of genetic material blood, skin and products of conception.

In connection with cancer studies, chromosome analysis can be performed for management of acute and chronic leukemia, myeloproliferative disorders, myelodysplastic syndromes, remission/relapse status and success rate of opposite sex bone marrow transplants and Fanconis anemia. Typical sample sources are bone marrow and peripheral blood, when the circulating blast count is above five percent.

Routine cytogenetic analyses typically are done on chromosome preparations that have been treated and stained to produce a banding pattern specific to each chromosome. This allows for the detection of subtle changes in chromosome structure. The most common staining treatment is called G-banding. A variety of other staining techniques are available to help identify specific abnormalities. Once stained metaphase chromosome preparations have been obtained, they can be examined under the microscope. Typically 15-20 cells are scanned and counted with at least 5 cells being fully analyzed. During a full analysis each chromosome is critically compared band-for-band with its homolog. It is necessary to examine these many cells in order to detect clinically significant mosaicism. Following microscopic analysis, photographs of selected chromosomes are made and typically subjected to cut-and-paste processing. Chromosomes can be arranged in pairs according to size and banding pattern into a karyotype. The karyotype allows the cytogeneticist to even more closely examine each chromosome for structural changes. A written description of the karyotype, which defines the chromosome analysis, is then made. Samples of a chromosome photograph and a karyotype chart (this chart prepared by practicing the present invention) appear in FIG. 1 and 2, respectively.

Gynecologists, pediatricians, oncologists and other medical specialists utilize the diagnostic services offered by genetic labs to identify genetic disorders. The referring doctors collect and send the samples to the laboratory for genetic studies. Special flasks and culture media are used to eliminate any possibility of infection or contamination during transport and handling. The samples are then processed in accordance with the proven lab procedures perfected and standardized for local conditions. Variations on a process are depicted in FIG. 3. When a sample is received, patient data and history are manually assembled. The sample is planted in a culture and incubated. After an incubation period, it is harvested and a slide is prepared from the sample. Various techniques for staining make the bands on chromosomes in the sample visible under a microscope. A well-trained technician studies the slide under the microscope and records observations. One or more photographs are taken using a black and white camera. When the roll of film has been fully exposed, it is developed and the photographs are printed. A trained technician cuts and paste chromosomes from the photographs to assemble a karyotype. The karyotypes are analyzed and a type report is prepared. The lab report giving the karyotype with full chromosome complement and pointing out the abnormality, if any, forms the basis for the referring doctor to plan the appropriate treatment.

Doctors and their patients want reliable results expeditiously. Typical turn-around-times for different type of samples are:

Amniotic fluid 10-20 days

CVS 12-15 days

Fetal Blood 5-6 days

Routine Blood 7-10 days

STAT Blood 3-4 days

Products of Conception 12-15 days

Bone Marrow 2-3 days

Fanconis Anemia 8-10 days

Accordingly, there is an opportunity to improve on processing, management and utilization of genetic data, including aspects of data collection, manipulation and delivery via a user interface.

### SUMMARY OF THE INVENTION

The present invention includes methods of and devices to create, maintain and take advantage of a cytogenetic database. Particular aspects of the present invention are described in the claims, specification and drawings.

### BRIEF DESCRIPTION OF THE DRAWINGS

FIG. 1 depicts a selected portion of a prepared chromosome sample.

FIG. 2 depicts arrangement of chromosomes into a karyotype.

FIG. 3 is a block diagram of a laboratory procedure from sampling through counseling.

FIG. 4 is a block diagram of a procedure utilizing aspects of the present invention.

FIG. 5 depicts user options presented by a cytogenetic data management program.

FIG. 6 is a user interface for setting up a cytogenetic data management program.

FIG. 7 is a user interface for patient data management.

FIG. 8 is a user interface and expanded file menu for a karyotype preparation screen.

FIG. 9 is a pair of lab report screens.

FIG. 10 is a user interface for chromosome analysis.

FIG. 11 is an additional user interface for access to ideograms.

FIG. 12 is an additional user interface for instruction.

FIG. 13 is an additional user interface for disease data.

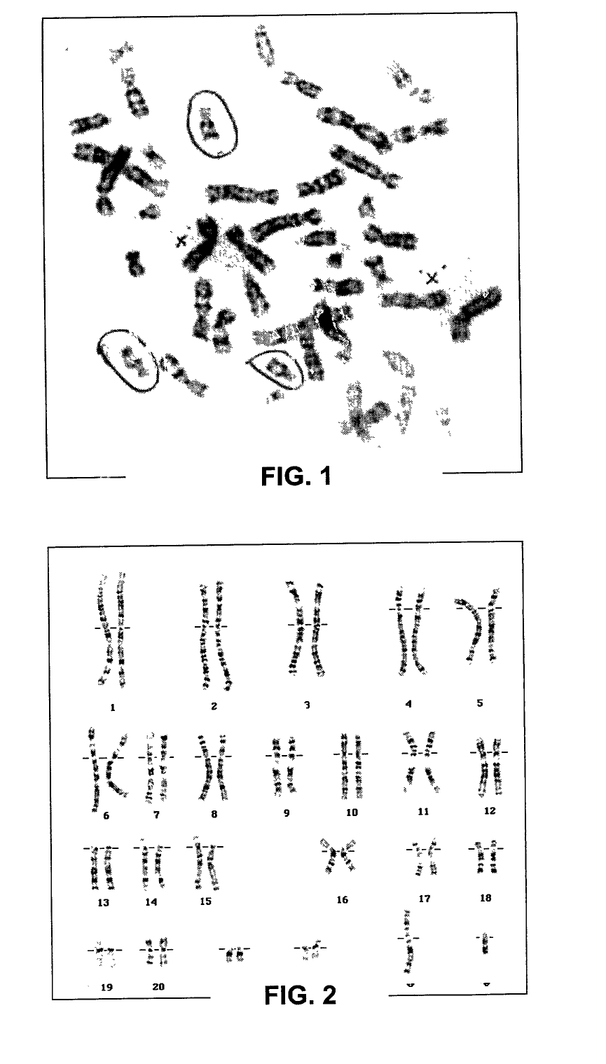

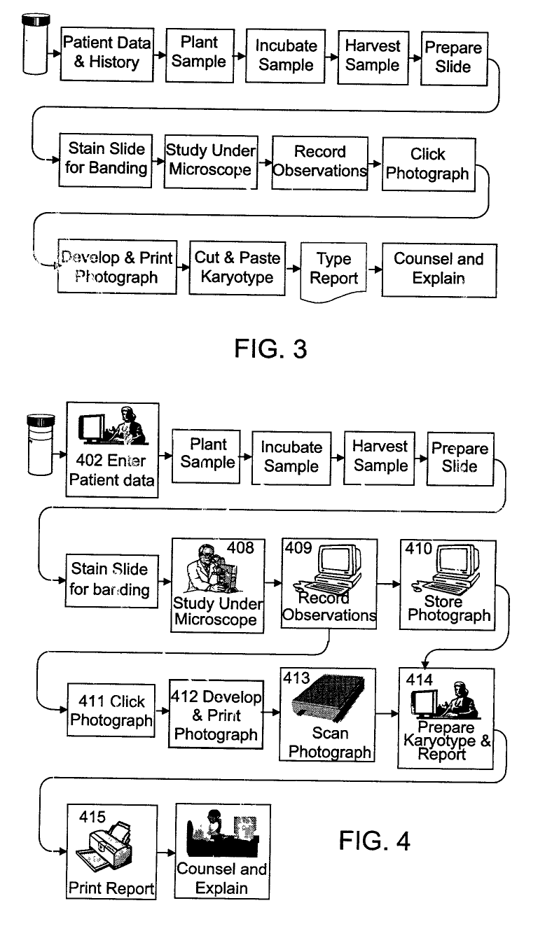

### DETAILED DESCRIPTION

The following detailed description is made with reference to the figures. Preferred embodiments are described to illustrate the present invention, not to limit its scope, which is defined by the claims. Those of ordinary skill in the art will recognize a variety of equivalent variations on the description that follows.

People are becoming increasingly aware of the risks associated with inherited diseases and genetic disorders, creating a growing demand for processing of genetic samples, analysis of the samples and reporting. The demand on the genetic labs to process more samples is growing day by day. The medical community is relying on lab reports for accurate diagnosis and subsequent treatment. The labs are expected to expedite the report preparation, which is possible only if the turn around time is reduced without having to sacrifice the quality of work. Processing the sample, preparing slide, identifying chromosomes through microscopic studies and detecting numerical and structural aberrations require trained and dedicated paramedical personnel who are always in short supply. Obtaining patient's bio-data along with the photograph of deformity, family history, pedigree, consanguinity, etc. and recording it systematically for storage and retrieval at the time of analysis and reporting facilitates accurate diagnosis of genetic disorders.

The pedigree handling includes linking a patient to relatives. This allows tracing of a patient's heredity and descendants and consideration of other family members. Data is collected for subjects and linked using the pedigree features. As a family grows or additional members become subjects, additional information is added. Once information has been collected, links and buttons are provided for direct access to related subjects. A list or family tree of related subjects can be obtained by pressing a pedigree button. Information regarding specific relatives can be obtained by selecting from the list or family tree.

The patient database built over a period of time is also useful for carrying out statistical analysis for sharing knowledge by presenting the findings in professional forums. Interconnection of patient databases and use of a standardized interface improves data collection and extends researchers' abilities to analyze data. Software that maintains the database(s) also can provide an audit trail of user actions. Deletion of a patient or subject record may make the record generally inaccessible, but an audit trail will preserve the deleted information, identify the user who deleted the information and track additional information about the transaction. This improves the integrity and security of the database(s).

Medical students and other workers need a tool to help them identify normal chromosomes and practice to achieve perfection. The repertoire a stored images that can be manipulated and worked on any number of times. Software for practice also can help develop a student's diagnostic skills by providing access to information on genetic disorders, their causes and effects. This information, presented alongside the actual cases, enhances a student's understanding of the genetic diseases.

Chromosome photography is essentially black and white, an art which is on the verge of extinction. Computer image capture and processing provides a viable alternative to the conventional black and white photography. Digital images can be used as references and teaching material.

A combination of features in a computer-assisted system can help genetic labs perform their job more efficiently and expeditiously. The teaching institutes can use the stored data for classroom instructions and interactive learning. Systematically collected data can be used for genetic studies and shared with the medical community.

FIG. 4 depicts a modified lab process, in which some steps are handled by a PC connected to a scanner and a printer. Patient data is entered into or accessed from a database to match a sample 402. Following microscopic analysis 408, either photographic 411 or computerized digital images 410 of the best quality metaphase cells are made. Programs used to record observations 409, store photographs 410, and prepare karyotype analyses and reports 414 have been written in Visual Basic 6.0 and access the back-end MS-Access database for single user and MS-SQL or Oracle for multiuser client server environment. Data storage and retrieval have been implemented using Microsoft ADO data controls. Kodak Eastman ActiveX controls for imaging are suitable for editing and manipulating image data. TWAIN compatible scanners and laser printers can be accessed from within the application to scan photographs 413 and print reports 415. The command button captions are self-explanatory and navigation is straightforward. Online help is available. The user interface is straightforward so that the person using the software can quickly adapt to the functionality offered by the application software. The operation this software is further described below.

After the software is started on the PC, a sign-on screen appears (not depicted in the figures,) asking the user to provide her/his name and the password. The software may be secured at three levels, more or less. The highest of the security level is assigned to the super user whose initial password is generated by the system at the time of installation. Once the installation is complete, the super user can change his password any time. The super user is given full rights to all the screens and the functionality offered by the system. He is the only person allowed to set up the system environment variables and create other users. He can add, delete and change any part of the database or connect the system to different databases. Initially, the super user will define the customer constants like name, address etc. and the paths for accessing various files. He will also be responsible for creating new databases, backing up the current databases, restoring the most recent database if the current database is destroyed, and deploying the software on client and server machines.

The next lower security level, level 2, could be assigned to the user who will interact with the system on a day-to-day basis. He will be assigned a profile, which will define the functions he can execute. For example, he may be allowed to add a record to the database but can't change or delete. He may be allowed to access certain screens but not all the screens. Controlled access based on roles and responsibilities will ensure data security and integrity. Typically lab people, instructors, management staff and teachers will be assigned level 2.

The last security level, level 3, could be assigned to the student who will primarily use the system for learning. In most cases the student will only view educational information and answer the questions prepared by the instructor.

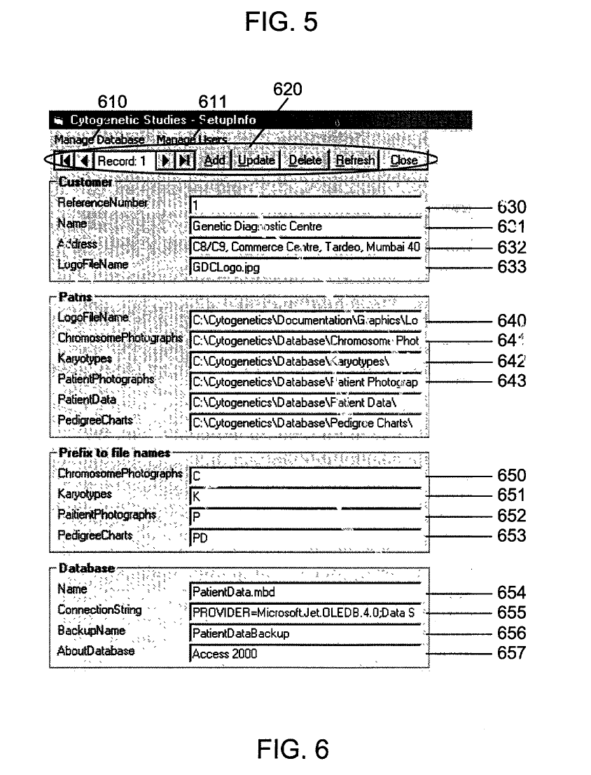

FIG. 5 shows various processing options of the software. In this embodiment, the options are to manage patient data 501, prepare a karyotype 502, or study chromosomes 503. By clicking on the appropriate option, the user can perform a variety of tasks. To exit the program, the user can click the “Exit Program” option or use a standard exit button.

FIG. 6 depicts a system setup interface. This initial screen is intended to be accessed only by a super user or a user with administrative rights, to enter customer details 630-633, file paths 640-645, file prefixes 650-653, database details 654-657. This information may be entered at the beginning or installation of the software (or defaults accepted) and thereafter when changes occur. Pulled down menus are provided 610, 611 to provide access to database and user management facilities, respectively. A standard database record interface 620 is used, along with commonly used record management facilities. A block of customer details information includes a reference number 630 for the customer record, the customer name 631 and address 632, and a connection to a customizable customer logo 633. A block of file paths identify locations for logo files 640, chromosome photographs 641, karyotypes 642, patient photographs (including abnormality photographs) 643, patient data 644 and pedigree charts 645. A block of file prefixes names is one way of establishing a file naming convention for chromosome photographs 650, karyotypes 651, patient photographs 652, and pedigree charts 653. A block of database information includes a file name for the database 654, on a connection string for invoking a database engine 655, a backup filename 656 and identifier of the database engine being used 657. Another menu option “Change Password” will allow an authorized user to change his password. The super user can create a new user by clicking on “Manage Users” menu option 611.

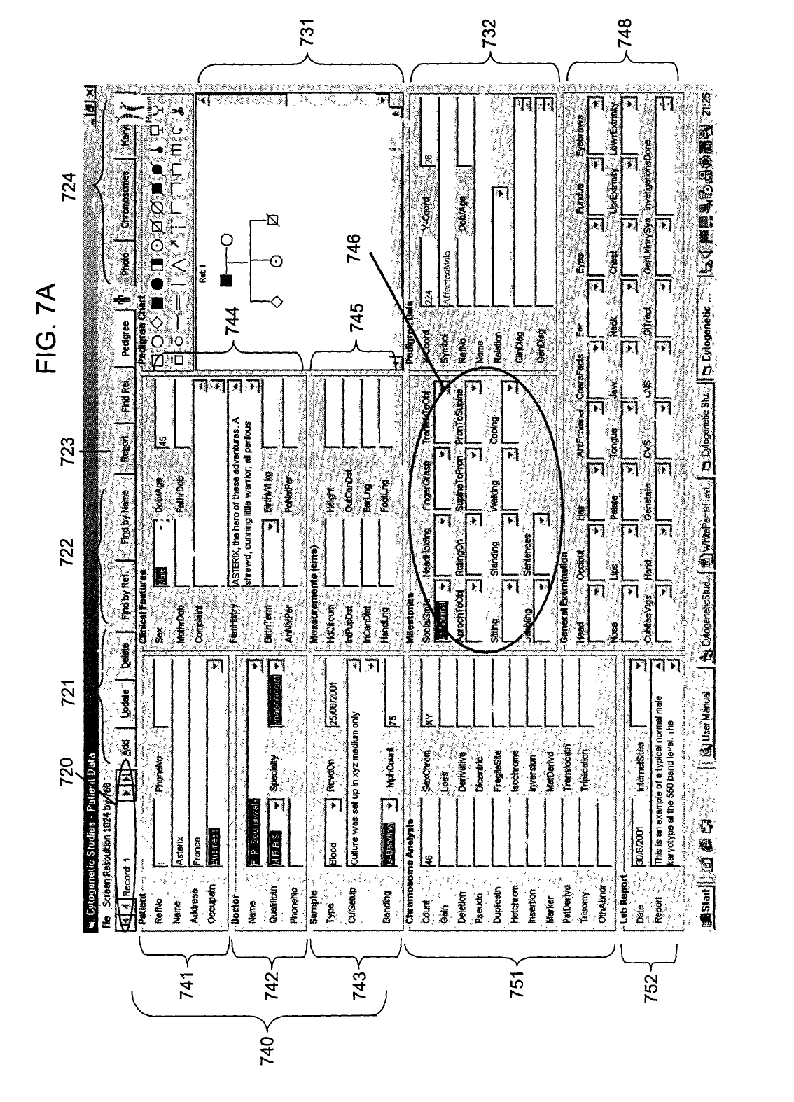

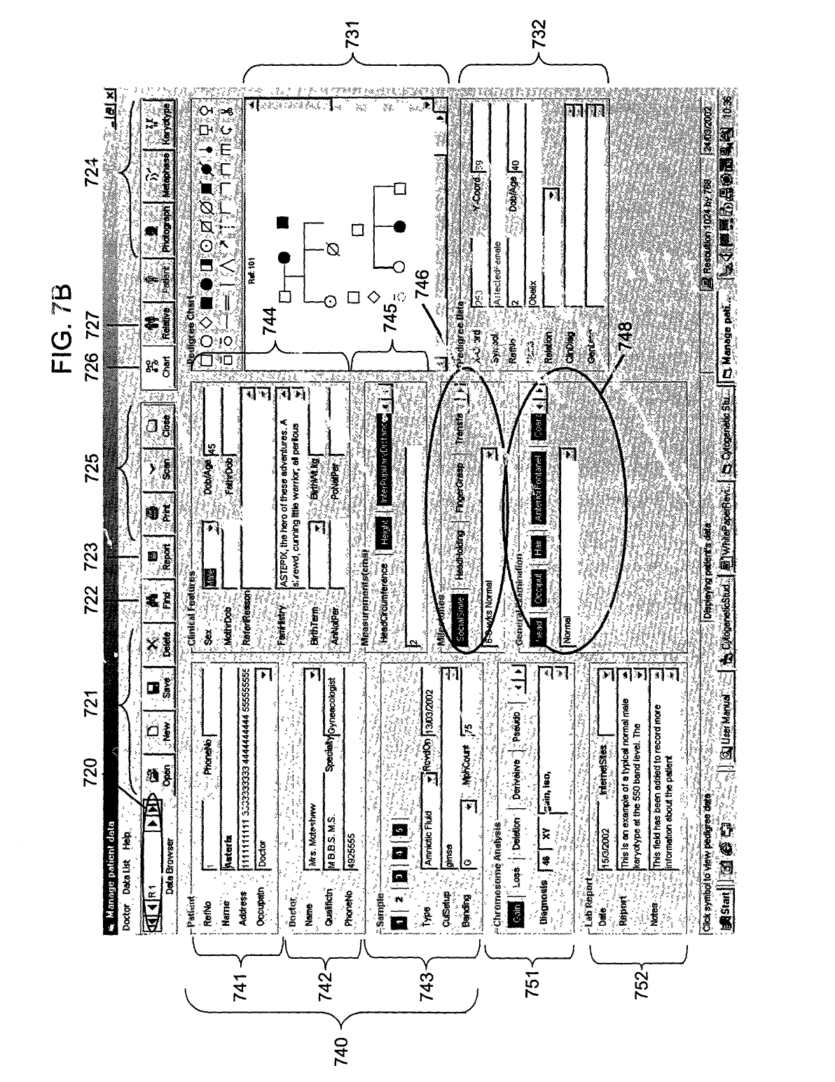

FIGS. 7A and 7B are variations on a user interface for managing patient data. After a sample is received at the lab, the lab assistant may collect relevant data about the patient. To enter the patient data, the user clicks on the option “Manage Patient Data” on the initial screen. The data entry screen depicted in FIGS. 7A and 7B appears. The lab assistant can then enter patient identification and intake data relevant to the incoming sample (collectively 740), such as patient's reference number, name, address (741), sex, age, family history (742), doctors' name (743) etc. The patient data may include groups of information, such as patient identification 741, cytogenetic sample description 743, referring doctor 742, chromosome analysis and abnormality diagnoses 751, lab report 752, clinical features 744, patient body feature 25 measurements 745, patient developmental milestones 746, general examination observations 748, and pedigree chart/data 731/732.

Drawing a pedigree chart 731 and entering the family members details 732 along with a pointer to the family members records is useful for genetic analysis. Tools are provided for composing the pedigree chart, consistent with standard representations. Pedigree information is particularly helpful in tracking affected members up and down the family tree and arriving at a fairly accurate diagnosis of the genetic disorder in the patient under test. It also helps predict the manifestation of the disorder down the line. A find relations button assists in collecting data corresponding to the pedigree chart and details.

A reference number is unique for a patient and is used as a primary key to access the database. It is preferred and the reference number never be changed. The system ensures that the reference number is stamped on all the photographs and karyotype. For photographs, this may be done by embedding the patient identifier in the file header, as a matter of convention in naming the file, or by embossing the number on the photograph, either visibly or as a watermark. For karyotypes, the patient identifier is associated with the data structure that assembles individual chromosomes of the karyotype. This helps avoid mix-up of the patient data with some other patient's photographs or karyotype.

Command buttons 724 are provided for displaying patient's photograph, metaphase photograph and the karyotype. Search by reference number or name 722 will fetch the patient's information quickly. Not depicted in FIG. 7 is a more general-purpose search engine to query the patient database by varying search criteria. The chromosome analysis group 751, is typically prepared from analysis of the karyotype and its chromosomes. The ADO data control 720 enables the user to step through the database sequentially forward and backward. The database commands 721 allow addition of a patient to the database, changing or updating data of the patient already existing in the database and deleting the patient data after confirmation and reconfirmation. A “Scan” command (725 in FIG. 7B) can be provided to initiate scanning of photographs, including patient photographs and non-digital photographs of prepared samples. A lab report can be generated by clicking on a “report” button 723. The main file menu (or a button 725) further gives the option to display and print the report on the laser printer. Access to a chart drawing window can be provided by a button 726, as can access to data about relatives of the patient 727. A plurality of samples 743 can be saved for a particular patient, as shown in FIG. 7B. The form can be condensed to fit on one screen by offering field choice bars, as shown in FIG. 7B, for chromosome analysis 751, measurements 745, milestones 746 and general examination 748. The field choice bar may expand the available field description space.

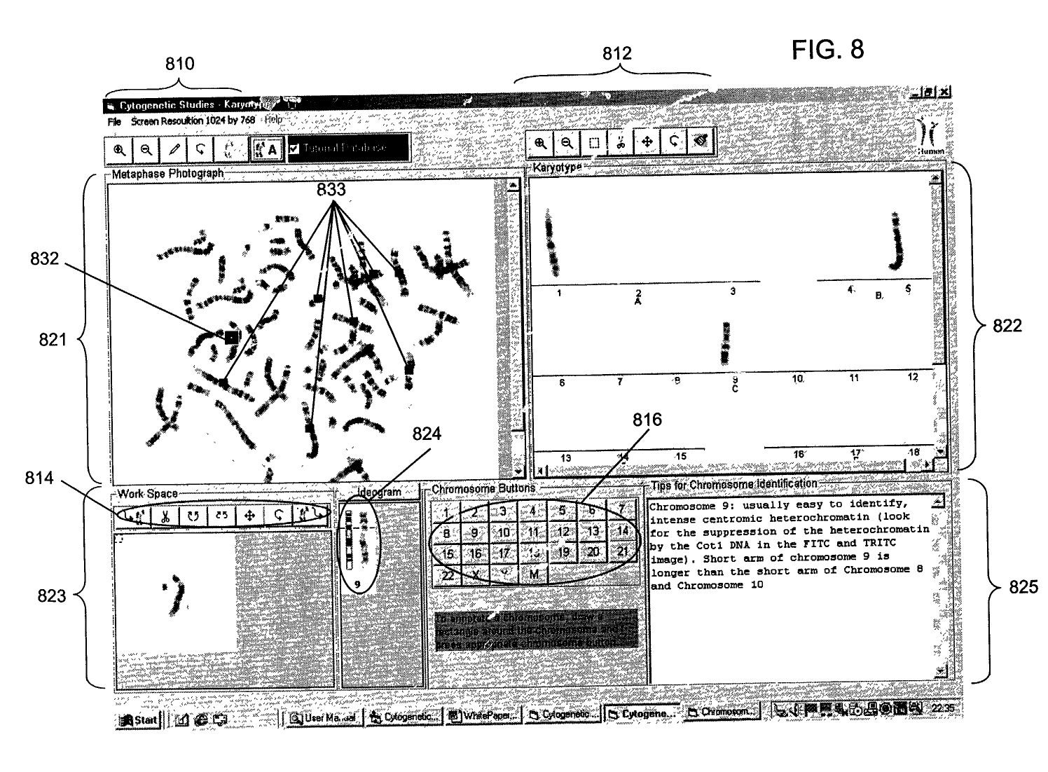

FIG. 8 is the initial “Prepare Karyotype” screen. A karyotype is a widely accepted format for data used in cytogenetic studies. A karyotype is included in a typical lab report given to a doctor or patient. The “Prepare Karyotype” screen explains step by step how a digital karyotype can be obtained from the digital chromosome photograph and what help may be available in identifying individual chromosomes.

Karyotype preparation from a conventional black & white chromosome photograph involves marking the field, counting the number of chromosomes, cutting each chromosome along its periphery, identifying each chromosome and pasting it at the correct place on the karyotype form. Considerable skill is required in identifying the chromosomes, particularly when the bands are not clear or the picture quality is poor. There is an inherent delay in the typical, photographic method of assembling karyotypes because developing and printing does not commence until roll of film in the microscope camera is completely exposed. Also, whether the picture quality is acceptable or not is known only after the role is developed and printed. If the picture quality is not acceptable, then the photograph must be taken again. This often leads to delays in report preparation. Therefore, it is preferable to have a digital camera attachment that can digitize the chromosome field under the microscope and send the digital image to the computer as a bit map file. The image can be viewed immediately on the computer screen to decide whether to accept it or scan some other field for better results. No waiting, no chemicals and no repetition. Both photographic and digital imaging alternatives are shown in the modified lab procedure of FIG. 4.

To support integrated digital image processing, the file menu provides access to three groups of commands for chromosome photographs, for patient photographs and for karyotypes. The self-explanatory commands include: Scan Chromosome Photograph; Open Chromosome Photograph; Save Chromosome Photograph; Save As Chromosome Photograph; Scan Patient Photograph; Open Patient Photograph; Save Patient Photograph; Save As Patient Photograph; Scan Karyotype; New Karyotype; Open Karyotype; Save Karyotype; and Save As Karyotype. The first group supports scanning the chromosome photograph obtained through conventional photography. The scanned image can be saved in any standard file format like BMP, JPG, and GIF etc. JPG format is preferred because this format generates a smaller file size saving disk space. While saving the file the system ensures that the reference number is embedded in the file, for instance in the file header, in coding of the file name or burned into the image either visibly or as a machine readable watermark. This precaution is necessary to avoid the mix-up of patient data and his graphic files. This precaution is generally applicable to all graphic files created by the system as well as externally generated files imported into the system. If the microscope has the digital camera the chromosome image can be imported online by reading the camera output or by imported near online by accessing downloaded files. Given the nature of digital media, there is no need to wait until a roll of film has been used and there is no delay in Unfinished work from previous session can be completed in the current session by exercising the “Open Chromosome Photograph” option. The chromosome photograph automatically goes into the picture frame marked as “Chromosome Photograph”. The next group of options in the file menu operates on the patient photograph namely scanning, opening and saving the photograph. The patient photograph does not participate in the karyotyping operation. This facility is merely for knowing who the patient is and relating to the diagnostics any deformity or abnormality that may be apparent from one or more photographs. The third group of options works on the karyotype. Scanning option for karyotype is generally not required, as the lab assistant will actually create the karyotype using the above screen. But in rare circumstance such as machine breakdown forcing manual operation may necessitate scanning of karyotype to complete the records. The “New Karyotype” option loads the blank template which the system uses for building the karyotype. Unfinished karyotype can be saved and opened in the next session to complete the work. Further options can be provided for direct capture from a digital cameral into the photograph window 821.

The actual karyotype build operation 414 may start with scanning the chromosome photograph 413, importing the file created by the digital camera 410 or capturing the digital image via a TWAIN or similar connection between the software and camera. Once the chromosomes are available in the picture frame 821 they can be annotated by embedding a patient number in the image header, by a file naming convention, or by embossing its identification number on its body, either visibly or as a watermark. Expert help can be called by pressing the ideogram button and then the corresponding chromosome button 816. An ideogram is a stylized line drawing representation of a chromosome. The ideogram appears in its picture frame 824 and the help appears in the help text box 825. At the end of the identification process, the software can automatically count the chromosomes complement, which for a normal human being should be equal to 46. More or less than 46 would mean numeric aberration.

A chromosome can be cut and pasted into the workspace 823 for cleaning the debris around the chromosome and to rotate it to a proper vertical orientation with respect to its long (q) and short (p) arms. Transfer to work space 823 is done by pressing the “Chromosome in” command button 814 followed by the Chromosome Button. A current chromosome in the workspace 823 can be marked with a distinctive marker 832 in the window 821. All of the chromosomes that have been transferred to the workspace can be marked 833, preferably with a contrasting color of marker (for instance, a black marker if the image is colored.) The individual chromosome image standing erect in the workspace 823 can then be transferred to the karyotype template 822 by drawing a selection rectangle around the chromosome and pressing the corresponding chromosome button 816. The completed karyotype can then be saved for reporting purposes.

Each picture frame is associated with a set of command buttons to enable the required functions. It is not necessary to complete the task in one go. One can always resume at the point at which one was in the preceding session. The status of pervious session is readily available because completed chromosomes are annotated with red mark placed by the system when the chromosome found its place in the karyotype. This tracking mechanism helps in knowing how many chromosomes were karyotyped and how many are remaining.

Image processing techniques can be added to this interface and/or software. In a semi-manual process, a user can select a chromosome by clicking on it. Graphic processing routines trace the boundary of the chromosome. In the case of overlapping chromosomes, for instance, the user can revise the system's tracing. Graphic routines can reorient the chromosomes to essentially vertical and allow the user to reverse the orientation by rotating the chromosome image or reflecting it. Image processing routines can compare a selected chromosome to ideograms for different chromosomes and suggest a classification, e.g., 1-22, X or Y. The user can revise the suggested classification. Image processing routines can further compare banding or other aspects of the chromosome to the matching ideogram and suggest differences in patterns, much as document comparison programs compare texts and identify differences. The image processing routines can suggest proper coding of the suggested differences. In an automatic process, the user can select a set of chromosomes to process and allow the program to perform the steps of a semi-manual process, constructing an audit trail or explanation of processing steps taken, instead of offering opportunities for user confirmation or modification of the process. During a quality assurance step, following automatic classification, the computer can show the user how the classification and analysis were performed. The user can control the verbosity of the system, as confidence builds and as vulnerabilities are recognized and corrected.

A checkbox called “Tutorial Database” located to the side of command buttons 810 turns on the program code, which in addition to pasting the chromosome to its designated place in the karyotype, also directs the chromosome to the database table called “Chromosome Data”. This feature is intended to build a metaphase record together with its individual chromosomes. This form is described below.

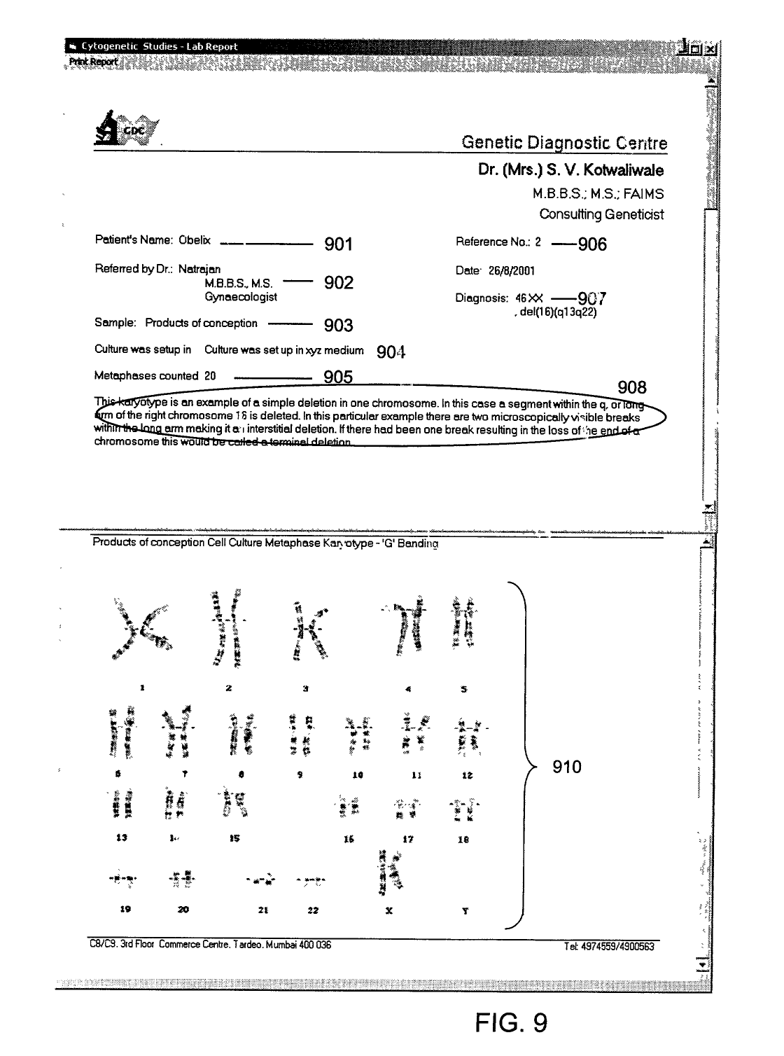

FIG. 9 depicts a “Lab Report” screen. Prior to printing the report it is presumed by the system that the diagnosis has been completed in all respects and the karyotype is ready. The user can then navigate to this screen by pressing the “Print” commend button in “Manage Patient Data” screen. The “Lab Report” screen displays the report that can be proof read for checking any missing information and ensuring that the reference number embedded on the karyotype is identical to the reference number shown on the top right corner. The name, address and logo of the lab are customizable. Report information comprises the patient name 901, the name and information about the referring doctor 902, the sample type 903, the incubation culture 904, the number of metaphases counted 905, a reference number 906, a diagnosis 907, and a narrative, for instance, corresponding to the diagnosis 908. The karyotype 910 typically is also included with the report. Once the report is verified for accuracy it can be printed by pressing the “Print Report” command button located on the top left corner.

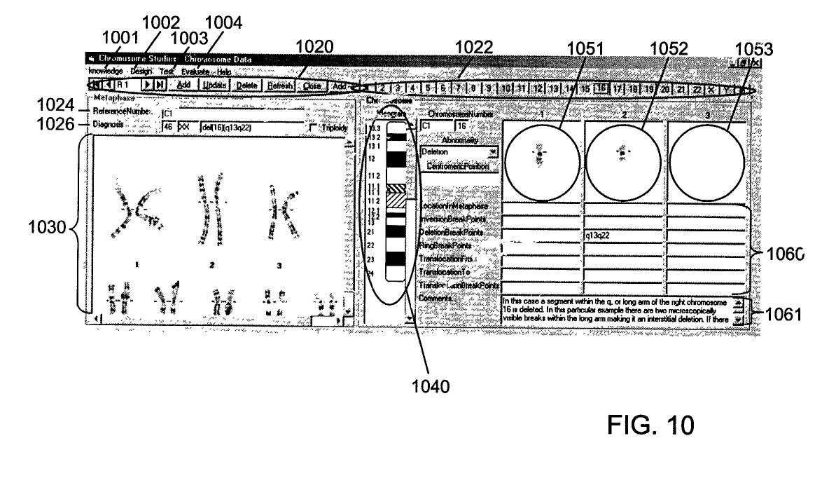

FIG. 10 depicts a “Cytogenetic Studies—Chromosome Data” screen. The screen opens up automatically while working with the metaphase to construct a karyotype by checking the box named “Tutorial Database.” The same screen can also be reached by pressing the “Study Chromosomes” label on the main screen. Clicking on the “knowledge” tab 1001 on the menu bar gives a number of options. The first option is “Enter Metaphase Data”. The next option is “Enter Chromosome Master Data”. By clicking on the appropriate picture box the user will be in a position to embed the graphic images into the database along with the relevant text. This form assists in creating a graphical database for developing tutorials for the students and designing suitable exercises so that the student can learn to identify the chromosomes. A karyotype 1030 is displayed. The student can be asked to count the chromosomes in the metaphase 821 to see if there is any numerical aberration in the metaphase. Individual chromosomes can readily be selected, for instance by using tabs or buttons 1022. Examples of the individual chromosomes 1051-1053, allow a student to closely study a particular structural aberration. A diagnosis can tell the student, for instance that there is a deletion on chromosome no. 16 1060. The student can see this deletion and read the notes below 1061 to see and correlate the disorder with this deletion. As time passes, the database will grow in size and provide a rich source of knowledge that can be referred by the student for enhancing his understanding of the subject with real life examples. A generalized search facility can assist a student in searching for examples of particular conditions.

This software supports composing tutorials. A cytogenetic database as described above contains data from which tutorials can be constructed. A system supporting composition provides access to the database and the cases it contains. Some of the fields for a case that may be used to construct tutorials include cytogenetic sample descriptions, family pedigree data (optionally in the form of a tree graphic), a chromosome set image, a karyotype form and one or more abnormality diagnoses. One or more images of physical abnormalities also may be stored, if available and applicable. References to case records of family members having abnormalities also may be useful, to illustrate how conditions are passed along genetically. Patient developmental milestone data, general physical examination data further may be combined in various permutations with these features. A user interface allows a teacher or other author to compose a tutorial from the database cases. The user selects a portion of one or more cases as an example. The example may involve various family members' cases. The user provides narrative information to teach from the example. The user further associates other cases as further examples or counter examples, to illustrate the teaching. The system stores the selected, provided and associated information. The user also may identify one or more students who are authorized to access the tutorial. These students may access the tutorial on-line, e.g., from a terminal connected to a tutorial system or a device connected by a network to the tutorial system. Patient identifying or other fields can be concealed from student tutorial view. Students having database access privileges may be allowed further access to the cytogenetic database, e.g., for more in-depth review of the example and associated cases or for further research into the teaching. A user equivalently may select a group of cases, instead designating one or more as examples and associating others with the examples. An instructor can use the same database to create a variety of exercises, which can be stored as templates and can be used to test and evaluate batches of students year after year.

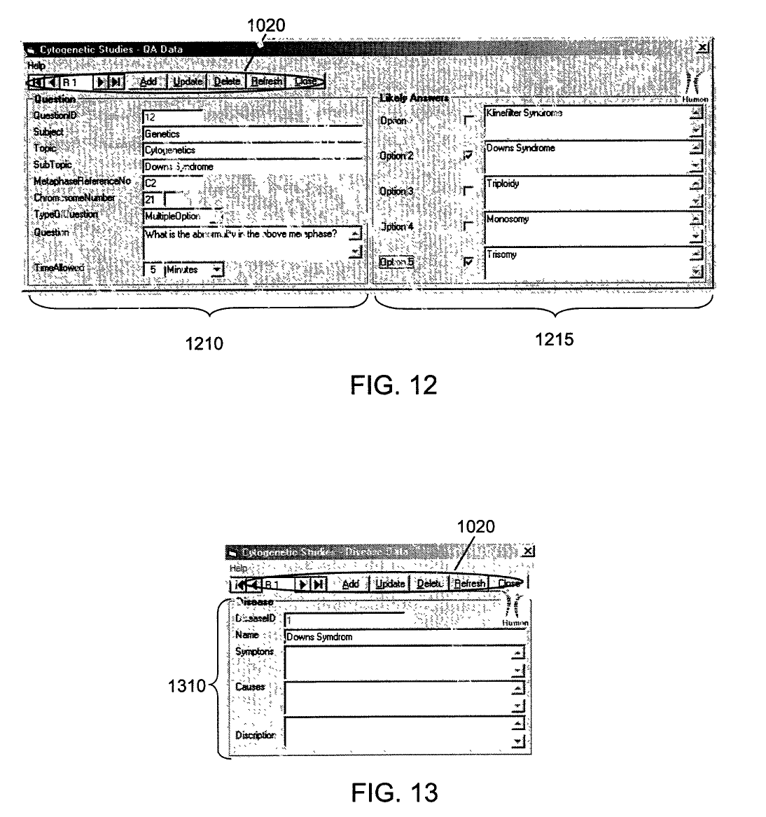

Support for preparing exercises can be provided from a database of cytogenetic cases. A user preparing cytogenetic problems and responses may be provided access to the database of cytogenetic cases, either with or without patient identifying information. The cytogenetic case preferably includes one or more chromosome set images, one or more images of abnormal chromosomes, from the chromosome set images and one or more chromosome abnormality diagnoses corresponding to the abnormal chromosomes. Through a user interface, the exercise preparer selects a portion of one or more cases to pose as a problem. As illustrated in FIG. 12, below, in addition to selecting a problem, the user can specify one or more correct and incorrect responses 1215. The problems, correct responses and incorrect responses are stored. Optionally, students having access to the problem set may be identified through the user interface. A student accessing the problems is presented with multiple choices.

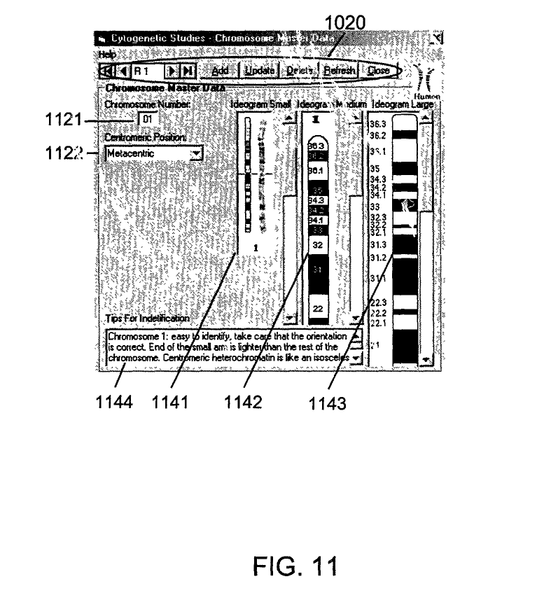

FIG. 11 depicts a “Cytogenetic Studies—Chromosome Master Data” screen. A child form, as shown in FIG. 11, pops up facilitating entry of master data for each of the 22 chromosomes and the 2 sex chromosomes. The interface comprises a chromosome number 1121, centromeric position data 1122, ideograms in a plurality of sizes 1141-1143 and the tips for identifying the chromosome 1144. This master data, once entered, is available as reference material. Defining more data fields to describe the properties, banding patterns, deletions, inversions, break points and disorders/abnormalities normally associated with the numeric and structural aberrations, as in FIG. 10, will further broaden the scope of learning.

FIG. 12 depicts a “Cytogenetic Studies—QA Data” screen. Pressing the other menu option in the “Chromosome Data” form will pop up the child form called “QA Data”. This form enables the instructor to form a question and compose up to 5 probable answers 1215. Out of these five probable answers one or more may be the correct answers. The instructor can check the correct answer/s and save the question to the QA database. Subject, topic and subtopic can classify the question and the time can be specified for answering the question 1210. A further screen, not depicted, will enable the instructor to compose a question paper by selecting the questions on a given topic or select them randomly. The question paper can then be assigned to a student for test and evaluation. When the student logs in and chooses the test option, the question paper assigned to him will be shown on the screen. The system will keep track of the time allotted to each question. When the allotted time expires or the student moves on to next question. A scorecard will be generated automatically and stored in the database. The instructor can, at his convenience, review the answers or have a hard copy as permanent record of how the student has faired in the test. One of ordinary skill will recognized the extensibility of this approach and the underlying data.

FIG. 13 depicts a “Cytogenetic Studies—Disease Data” screen. The menu option “Knowledge” 1001 on the “Chromosome Data” has a submenu “Enter Disease Data”. Clicking on this option shows the child form named “Disease data” depicted in FIG. 13. This form can be used to input the name of the disease, its symptoms, causes and description of the disease 1310. The student can use this part of the database to find a suitable answer to the question. The same data can also be used for teaching the various genetic disorders.

An article of manufacture practicing aspects of the present invention may include a recording medium (machine readable memory) on which a program is impressed that carries out the methods described above. It may be program transmission medium across which a program is delivered that carries out the methods described above.

While the present invention is disclosed by reference to the preferred embodiments and examples detailed above, it is understood that these examples are intended in an illustrative rather than in a limiting sense. It is contemplated that modifications and combinations will readily occur to those skilled in the art, which modifications and combinations will be within the spirit of the invention and the scope of the following claims.

We claim as follows:

1. A computer system assisted method of processing a prepared sample of genetic material, including:
recording characteristics of the prepared sample via a computer system keyed to a patient identifier;
associating one or more digitized images of selected sets of chromosomes in the prepared sample with the patient identifier;
selecting from the digitized images individual chromosomes, reorienting the portions of the digital images corresponding to the individual chromosomes and classifying the individual chromosomes as elements of a karyotype;
storing on a computer accessible memory associated with the patient identifier the characteristics of the prepared sample, the digitized images, the classified elements of the patient karyotypes.

2. The method of claim 1, further including capturing the digital images and associating the digital images with the patient identifier under control of the computer system.

3. The method of claim 2, wherein the patient identifier is associated with the digital images by embedding the patient identifier in a header of the digital images.

4. The method of claim 2, wherein the patient identifier is associated with the digital images by naming files comprising the digital images.

5. The method of claim 2, wherein the patient identifier is associated with the digital images by visibly embossing the patient identifier on the digital images.

6. The method of claim 2, wherein the patient identifier is associated with the digital images by invisibly embedding the patient identifier as a watermark in the digital images.

7. The method of claim 1, wherein selecting from the digitized images comprises drawing a boundary around a selected area of the digitized images.

8. The method of claim 1, wherein selecting from the digitized images comprises manual selection of a portion of an individual chromosome and automatic tracing of adjacent portions of the digitized images that correspond to the individual chromosome.

9. The method of claim 1, wherein reorienting the portions of the digitized images comprises manually selecting a rotation angle.

10. The method of claim 1, wherein reorienting the portions of the digitized images comprises automatically selecting a rotation angle.

11. The method of claim 1, wherein classifying the individual chromosomes comprises manually selecting a chromosome identifier.

12. The method of claim 1, wherein classifying the individual chromosomes comprises manual comparison of the portions of the digital images corresponding to the individual chromosomes to one or more ideogram patterns.

13. The method of claim 1, wherein classifying the individual chromosomes comprises automatic comparison of the portions of the digital images corresponding to the individual chromosomes to one or more ideogram patterns.

14. The method of claim 1, further including comparing at least one element of the karyotype to an ideogram and recording one or more genetically significant differences between the element and the ideogram.

15. The method of claim 14, further including providing a visual comparison between the element of the karyotype and the ideogram, wherein a plurality of sizes of ideogram are provided and one size of the ideogram is similar in size to the element of the karyotype.

16. The method of claim 14, wherein the genetically significant differences include at least one of location in metaphase, inversion break points, deletion break points, ring break points, translocation from, translocation to, or translocation break points.

17. The method of claim 14, wherein storing further includes storing the genetically significant differences.

18. The method of claim 14, wherein storing further includes storing a pedigree chart for the patient.

19. The method of claim 14, wherein storing further includes storing a set data for that describes one or more relatives of the patient.

20. A user interface for processing a digital image of chromosomes, including:
a digital image window and logic to select an individual chromosome from the digital image window;
a work space adapted to receive selected individual chromosome and logic to reorient the selected individual chromosome;
a form having positions corresponding to elements of a karyotype and being adapted to receive the selected individual chromosome from the workspace.

21. The method of claim 20, further including a display at least one ideogram for comparison near the selected individual chromosome.

22. The method of claim 21, wherein the display includes a plurality of sizes of the ideogram and one size of the ideogram is similar in size to the selected individual chromosome.

23. A computerized database, comprising a data structure for cytogenetic case data, the data structure including:
patient identification data;
cytogenetic sample descriptive data;
patient intake data;
patient body feature measurement data;
patient family pedigree data;
a chromosome set image;
a karyotype form, comprising portions of the chromosome set image; and
one or more chromosome abnormality diagnoses.

24. The computerized database of claim 23, the data structure further including:
patient developmental milestone data;
patient general physical examination data; and
a patient family pedigree graphic chart.

25. The method of claim 24, the data structure further including one or more images of one or more physical abnormality of the patent.

26. A method of composing cytogenetic problems and responses, the method including:
providing access to a database of cytogenetic cases, the cases including:
one or more chromosome set images;
one or more images of abnormal chromosomes, from the chromosome set images;
one or more chromosome abnormality diagnoses corresponding to the abnormal chromosomes;
providing a user interface adapted for a user to
select a portion of one or more cases posing a problem;
specify one or more correct responses to the problem;
specify one or more incorrect responses to the problem;
storing the problem, the correct responses and the incorrect responses on a machine readable memory.

27. The method of claim 26, wherein the user interface is further adapted to identifying one or more students to whom the problem will be posed and the step of storing further includes storing the identification of students.

28. A method of composing tutorial covering cytogenetic problems, the method including:
providing access to a database of cytogenetic cases, the cases including:
cytogenetic sample descriptive data;
patient family pedigree data;
a chromosome set image;
a karyotype form, comprising portions of the chromosome set image; and
one or more chromosome abnormality diagnoses;
providing a user interface adapted for a user to
select a portion of one or more cases as an example;
provide narrative information regarding the example;
associate additional illustrative cases with the example,
storing the example, the narrative information and the association of additional illustrative cases on a machine readable memory.

29. The method of claim 28, wherein the user interface is further adapted to identifying one or more students to whom the problem will be posed and the step of storing further includes storing the identification of students.
